(19) United States
(12) Patent Application Publication
(10) Pub. No.: US 2017/0026730 A1
(43) Pub. Date: Jan. 26, 2017

(54) MICROPHONE WITH TEMPERATURE SENSOR

(71) Applicant: Knowles Electronics, LLC, Itasca, IL (US)

(72) Inventors: John J. Albers, Chicago, IL (US); Joshua Watson, Aurora, IL (US); Lance Barron, Plano, TX (US); Kurt B. Friel, Sycamore, IL (US); Norman Dennis Talag, Woodridge, IL (US)

(73) Assignee: Knowles Electronics, LLC, Itasca, IL (US)

(21) Appl. No.: 15/216,628

(22) Filed: Jul. 21, 2016

Related U.S. Application Data
(60) Provisional application No. 62/195,879, filed on Jul. 23, 2015.

(51) Int. Cl. H04R 1/04; G01K 7/16; H04R 19/00; G01K 1/14

(52) U.S. Cl. CPC H04R 1/04; G01K 1/14; G01K 7/16; H04R 19/005; H04R 2201/003

(57) ABSTRACT

A microphone includes a base, a MEMS device, and an integrated circuit. The MEMS device includes a diaphragm and a back plate. The MEMS device is connected to the integrated circuit. The microphone also includes a temperature sensor. A lid enclosed the MEMS device and the integrated circuit.

### CROSS-REFERENCE TO RELATED APPLICATIONS

This application claims the benefit of and priority to U.S. Provisional Patent Application No. 62/195,879, filed July 23, 2015, the entire contents of which are incorporated herein by reference.

### TECHNICAL FIELD

This application relates to microphones and, more specifically, to microphones that include sensors.

### BACKGROUND OF THE INVENTION

Different types of acoustic devices have been used through the years. One type of device is a microphone. In a microelectromechanical system (MEMS) microphone, a MEMS die includes a diagram and a back plate. The MEMS die is supported by a substrate and enclosed by a housing (e.g., a cup or cover with walls). A port may extend through the substrate (for a bottom port device) or through the top of the housing (for a top port device). In any case, sound energy traverses through the port, moves the diaphragm and creates a changing potential of the back plate, which creates an electrical signal. Microphones are deployed in various types of devices such as personal computers or cellular phones.

In many different situations, it is desirable to have sensors deployed with, within, or at the microphone. For example, in cellular phones it is often desirable to know the outside temperature for various reasons or applications. Sensor chip-like elements have been deployed in microphones. However, these sensors are bulky and take up space. Because of their size, they increase the microphone size, and this is not desirable in many situations. In many situations, the size of the microphone is fixed, and so placing a sensor in the microphone may be impossible to do within the size constraints.

The problems of previous approaches have resulted in some user dissatisfaction with these previous approaches.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 comprises a perspective block drawing of a microphone according to various embodiments of the present invention;

FIG. 2 comprises a side cutaway drawing of a microphone according to various embodiments of the present invention;

FIG. 3 comprises a perspective drawing of a microphone according to various embodiments of the present invention;

FIG. 4 comprises a drawing of the underside of the lid showing the temperature sensor structure according to various embodiments of the present invention;

FIG. 5 comprises a circuit diagram of an integrated circuit and temperature sensor structure according to various embodiments of the present invention;

FIG. 6 comprises a drawing of a flex circuit board that includes a temperature sensor structure according to various embodiments of the present invention;

FIG. 7 comprises a perspective view of a MEMS device with a temperature sensor structure according to various embodiments of the present invention;

FIG. 8 comprises a top view of a MEMS device with a temperature sensor structure according to various embodiments of the present invention.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### DETAILED DESCRIPTION

The present approaches provide a temperature sensor that is in, on, integrated with, and/or at the lid of a micro electro mechanical system (MEMS) microphone. In disposing the sensor on the lid, significant space savings are achieved. Consequently, a small-sized microphone is provided and achieved allowing the microphone deployed in applications where miniaturization is required or advantageous.

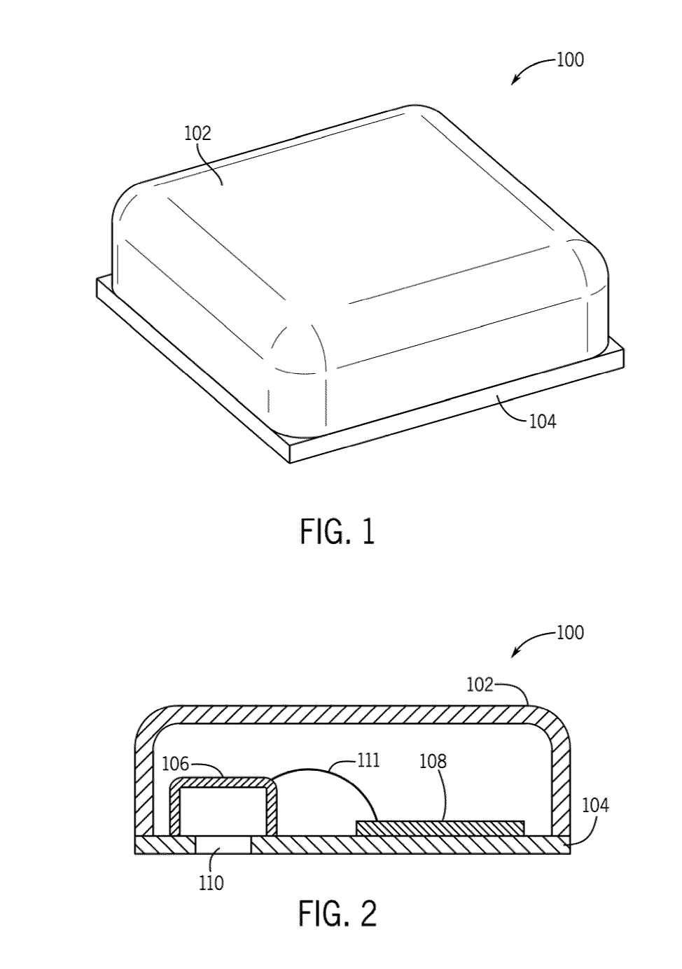

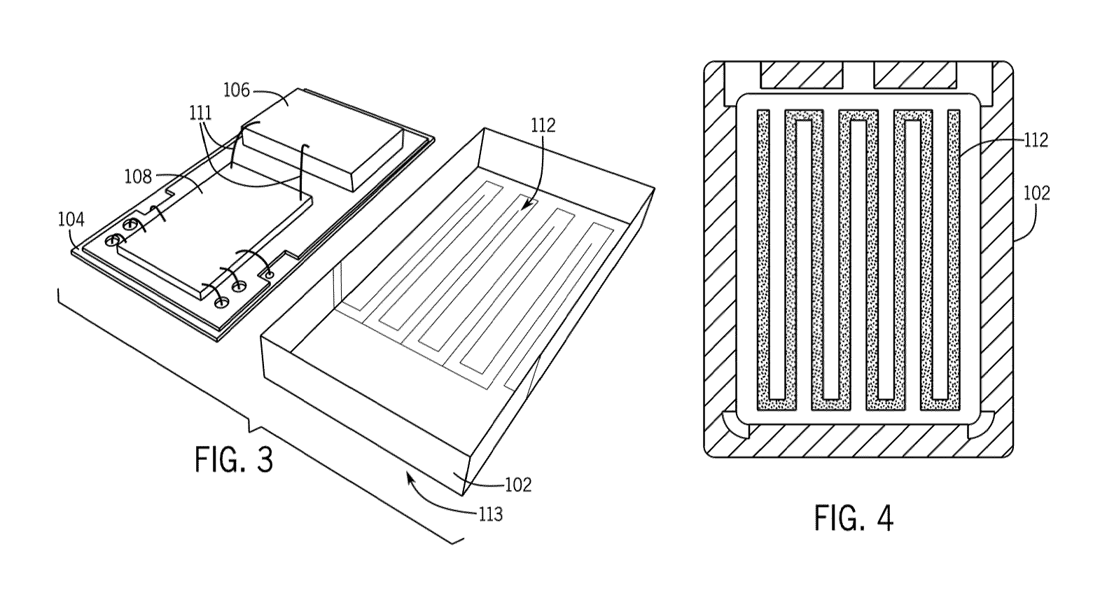

Referring now to FIG. 1, FIG. 2, FIG. 3, and FIG. 4, one example of a microphone 100 including a temperature sensor that is embedded in, at, on, or integrated into the lid of the microphone 100 is described. The microphone 100 includes a lid 102, a base 104, a micro electro mechanical system (MEMS) device 106 (including a diaphragm and a back plate); and an integrated circuit 108.

It will be appreciated that the lid 102 in this example is a one-piece can type device. Alternatively, the lid 102 may have walls with a flat cover over the walls. In any case, the lid 102 encloses the MEMS device 106 and the integrated circuit 108. A port 110 extends through the base 104. Sound enters through the port 104, moves the diaphragm of the MEMS device 106, and electrical signal is created and this is transmitted by wires 111 to the integrated circuit 108. The lid 102 acts as a ground shield 113.

The lid has a temperature sensor structure 112. The temperature sensor structure 112 is a material with a known temperature coefficient that is on the lid opposite the integrated circuit 108. The structure 112 is in one aspect a winding, snake-like structure. Other configurations are possible. The metal of the structure 112 is formed in any convenient way in the lid 102, on the lid 102, or integrated with the lid 102. The structure 112 is a metallic structure in one example.

The integrated circuit 108 is coupled to the temperature sensor structure 112. The integrated circuit 108 drives the sensor structure 112 with a current. A delta voltage (voltage difference or differential) is measured. The delta voltage relates to the temperature. The temperature sensor structure 112 forms an equivalent resistance and the delta voltage is measured across this resistance.

In one example, laser direct structuring (LDS) approaches can be used to form the sensor structure 112. In LDS approaches, plated metal traces are applied to the inside surface of a molded plastic cover. In one example, this structure will have a positive temperature coefficient (resistance increases as temperature increases). An inrush of current from the integrated circuit 108 is used to measure the voltage drop across the trace. This approach effectively turns the inside of the microphone assembly into a resistive temperature device (RTD).

It will also be appreciated that the approaches can also be applied to MEMS on lid configurations. In this case, the MEMS device may be disposed on the lid of the microphone. A port may extend through the lid to allow sound to actuate the MEMS device. The integrated circuit 108 may also be disposed on the lid. The temperature sensor structure 112 is disposed on the base (rather than on the lid).

In one example of the operation of the examples of FIGS. 1-4, the integrated circuit 108 supplies current to the support structure 112. The integrated circuit 108 sensed a voltage delta or drop across the support structure and this voltage delta is representative of sensed temperature. The integrated circuit 108 measures this temperature, converts it into digital form, and may send this digital sensed temperature to an external electronics device. The integrated circuit 108 may couple to traces on the base and the traces may couple to external pads, and the external pads may couple to a consumer electronics device may be incorporated into a cellular phone, tablet, personal computer, or lap top to mention a few examples.

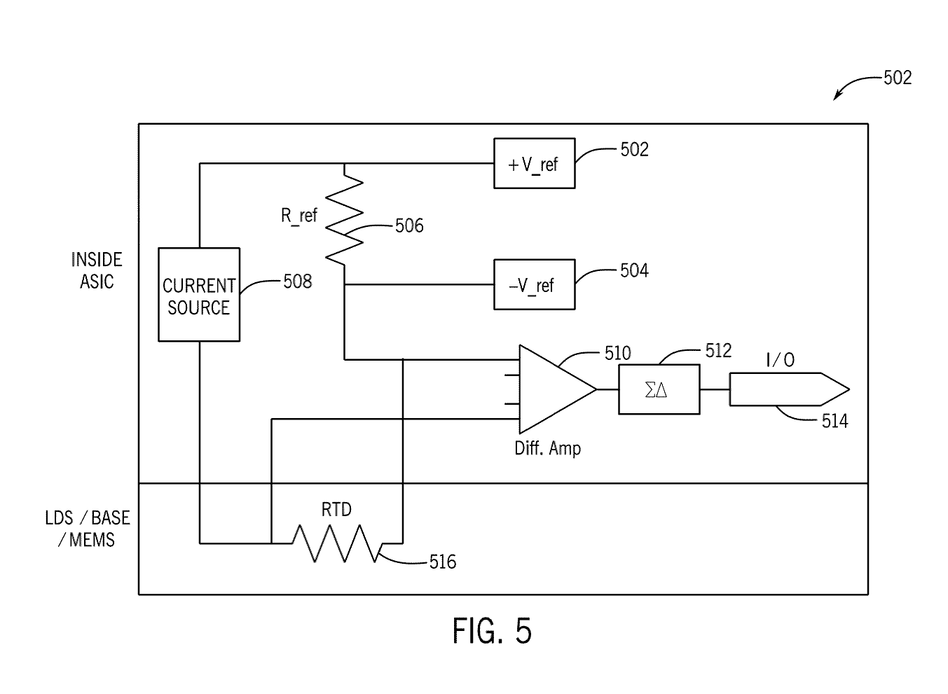

Referring now to FIG. 5, one example of an integrated circuit structure is described. An integrated circuit 502, includes a positive voltage reference 502, a negative voltage reference 504, a reference resistor 506, a current source 508, a differential amplifier 510, analog to digital converter 512, and an input/output (I/O) pin 514.

The integrated circuit 502 is coupled to a resistive temperature device (RTD) 516. The RTD 516 is in one example is a temperature sensor structure disposed at, in, or integrated with the lid of a microphone (e.g., the structure 112) of the example of FIGS. 1-4). In other examples and as described elsewhere herein, the RTD 516 is disposed at , on, or with the MEMS device included with the microphone. In still other examples, the RTD 516 is formed or disposed on a flex circuit board that is coupled to the underside of the lid.

In one example of the operation of the integrated circuit of FIG. 5, the current source 508 supplies current to the RTD 516. A voltage drop or differential occurs over the RTD 516. This voltage drop is representative of temperature. The voltage drop is measured by the differential amplifier 510 (which has been biased by the two reference voltages 502 and 504). The analog-to-digital converter 512 converts the analog difference voltage (representing sensed temperature) to digital form and this digital value is supplied to the I/O pin 514. The I/O pin 514 may couple to the exterior of the microphone assembly (e.g., through traces in the base of the assembly to pads, which couple to consumer electronic devices). The sensed temperature now in digital form can then be utilized by these consumer devices.

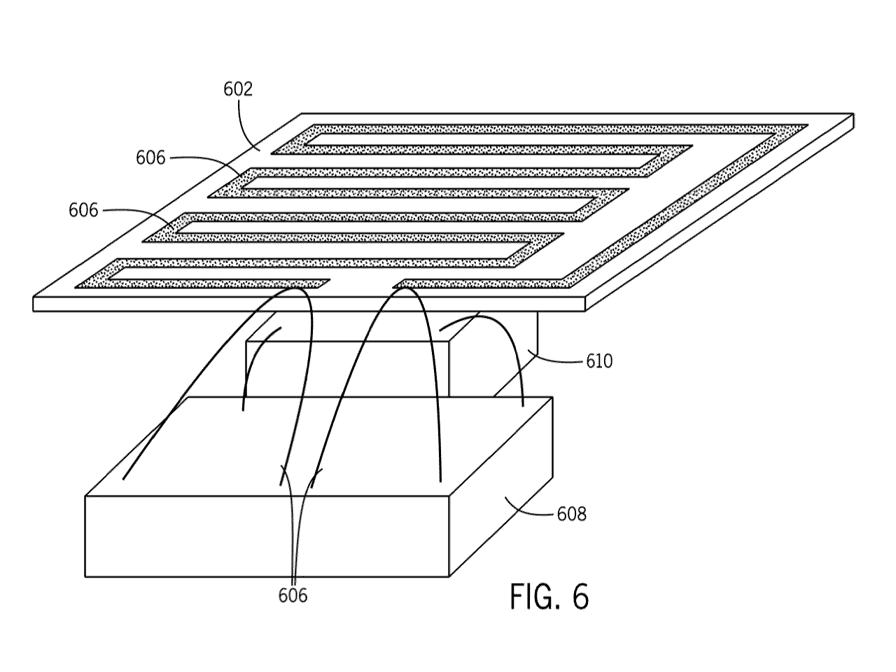

Referring now to FIG. 6, another example of a temperature sensor is described. A flex board 602 includes a temperature sensor structure 606, which in one aspect are plating traces formed on the flex board 602. The flex board 602 is coupled to the underside of the lid of the microphone (e.g., by gluing or welding). Jumper wires 606 (e.g., constructed of gold) couple the temperature sensor structure 606 to an integrated circuit 608. Jumper wires 610 couple the integrated circuit 608 to a MEMS device 610. Thus, in contrast to the example of FIGS. 1-4, the temperature sensor is on a support structure that is itself attached to the underside of the lid, rather than on the lid itself.

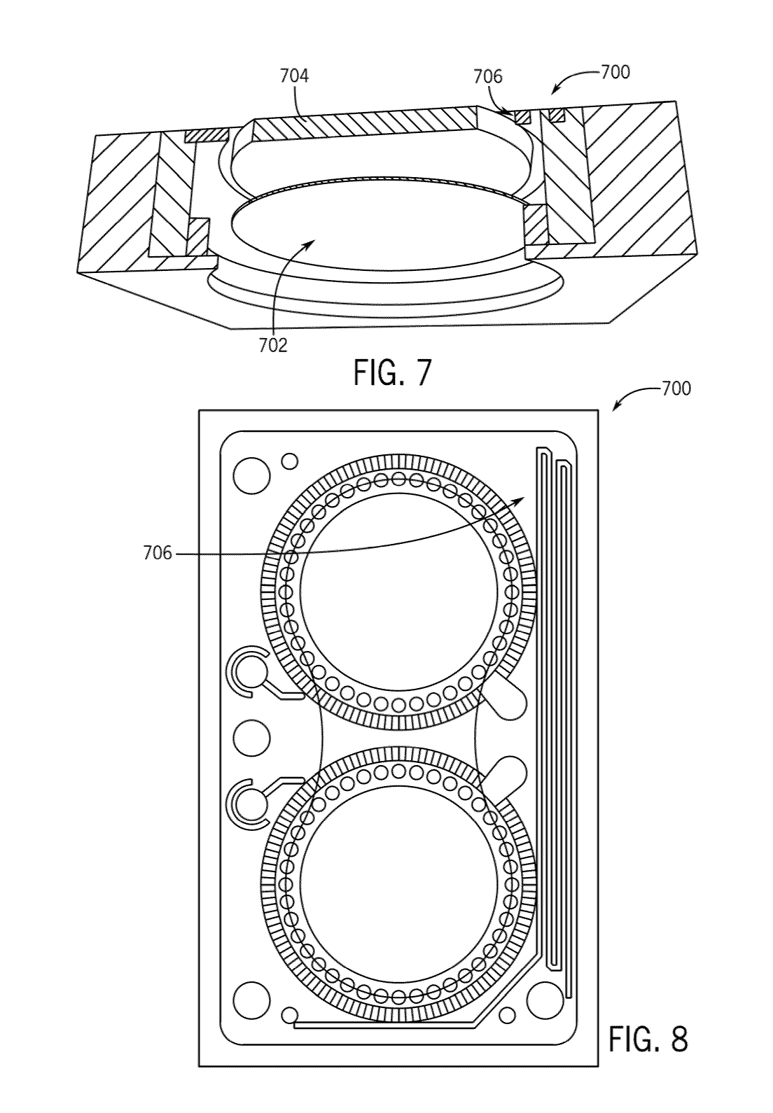

In other approaches and now referring to FIG. 7 and FIG. 8, the MEMS device can be modified. As shown, the MEMS device 700 includes a diaphragm 702 and a back plate 704. A material with a stable temperature coefficient is formed onto the MEMS device 700 to form a trace or snake like winding structure 706. The structure 706 may be coupled to an integrated circuit (or to the structures on the lid) and driven as described above. The material used to form the structure 706 may be a metal or a doped semiconductor. This approach has the advantage of a sensor placement that is closer to the environment exterior to the microphone. In other implementations, the sensor can be a separate sensor, e.g., a silicon based sensor, which is attached to the base or on the lid. In these implementations, the sensor can be connected to the integrated circuit. In other implementations, the sensor can be integrated into the integrated circuit.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A microphone comprising:
a base;
a micro electro mechanical system (MEMS) device including a diaphragm and a back plate;
a temperature sensor;
an integrated circuit connected to the MEMS device and the temperature sensor;
a lid, wherein the base and the lid enclose the MEMS device and the integrated circuit.

2. The microphone of claim 1, wherein the temperature sensor is a resistive temperature device.

3. The microphone of claim 1, wherein the temperature sensor is attached to the lid.

4. The microphone of claim 3, wherein the lid comprises a port that extends through the lid.

5. The microphone of claim 4, wherein the integrated circuit is attached to the base.

6. The microphone of claim 1, wherein the temperature sensor is contained within the lid.

7. The microphone of claim 1, wherein the temperature sensor is contained on the MEMS device.

8. The microphone of claim 1, wherein the temperature sensor is attached to the base.

9. The microphone of claim 8, wherein the base comprises a port that extends through the base.

10. The microphone of claim 9, wherein the integrated circuit is attached to the lid.

11. The microphone of claim 1, wherein the temperature sensor comprises plating traces.

12. The microphone of claim 11, further comprising a flex board, wherein the plating traces are formed on the flex board, and wherein the flex board is attached to the lid.

13. A microphone comprising:
a base;
a micro electro mechanical system (MEMS) device including a diaphragm and a back plate;
a temperature sensor, wherein the temperature sensor comprises a metallic structure;
an integrated circuit connected to the MEMS device and the temperature sensor;
a lid, wherein the base and the lid enclose the MEMS device and the integrated circuit.

14. The microphone of claim 13, wherein the temperature sensor is a resistive temperature device.

15. The microphone of claim 13, wherein the temperature sensor is attached to the lid.

16. The microphone of claim 15, wherein the lid comprises a port that extends through the lid.

17. The microphone of claim 16, wherein the integrated circuit is attached to the base.

18. The microphone of claim 13, wherein the temperature sensor is contained within the lid.

19. The microphone of claim 13, wherein the temperature sensor is contained on the MEMS device.

20. The microphone of claim 13, wherein the temperature sensor is attached to the base.
